(19) United States
(12) Patent Application Publication
(10) Pub. No.: US 2006/0068361 A1
(43) Pub. Date: Mar. 30, 2006

(54) Adapter for integrating an endoscope and ultrasonic scaler

(75) Inventors: Hans Jorg Bergler, Bingen (DE); Keith Allan Sather, Lake Forest, CA (US)

Correspondence Address: STETINA BRUNDA GARRED & BRUCKER, 75 ENTERPRISE, SUITE 250, ALISO VIEJO, CA, 92656, US

(73) Assignee: Dentalview, Inc.

(21) Appl. No.: 11/224,392

(22) Filed: Sep. 12, 2005

Related U.S. Application Data
(60) Provisional application No. 60/613,147, filed on Sep. 24, 2004.

(51) Int. Cl. A61C 3/03; A61C 17/02

(52) U.S. Cl. 433/86; 433/85; 433/119

(57) ABSTRACT

Provided is an adapter which is specifically configured for selectively maneuvering a distil tip of a scaler in close proximity to an endoscope tip of an endoscope. The adapter comprises a scaler holder and an endoscope holder. The scaler holder is configured to support the scaler. The endoscope holder is connected to the scaler holder and is configured to moveably support the endoscope. The adapter further comprises a thumbwheel which eccentrically couples the endoscope holder to the scaler holder such that rotation of the thumbwheel effectuates rotation of the endoscope tip about the distil tip of the scaler.

### CROSS-REFERENCE TO RELATED APPLICATIONS

This application claims priority to pending U.S. Provisional Patent Application No. 60/613,147 entitled ADAPTER FOR INTEGRATING AN ENDOSCOPE AND ULTRASONIC SCALER filed on Sep. 24, 2004, the entire contents of which is incorporated by reference herein.

### STATEMENT RE: FEDERALLY SPONSORED RESEARCH/DEVELOPMENT

Not Applicable

### BACKGROUND OF THE INVENTION

The present invention relates generally to dental equipment and, more particularly, to endoscopes, ultrasonic scalers and to an adapter that is specifically configured to integrate an endoscope and an ultrasonic scaler into a single hand tool. The adapter is also specifically configured to allow for a tip of the endoscope to be moveable or rotatable around a tip of the ultrasonic scaler such that a dentist cleaning a patient's teeth with the ultrasonic scaler may adjust the area to be viewed by manipulating the relative position of the endoscope in relation to the scaler.

Dentists typically utilize several different instruments in treating patients. For example, dentists may use hand instruments, ultrasonic instruments, sonic instruments and rotating instruments (i.e. working instruments) as well as cameras and endoscopes (i.e., viewing instruments). Hand instruments typically comprise a working part or a blade, a shank and an elongate handle. The blade of the hand instrument may be shaped in the form of a curate, sickle, hoe, chisel or a file.

Such hand instruments may be used to treat a variety of periodontal diseases such as removal of the buildup of plaque or dental calculus by performing a scaling or root planing procedure on the patient with the hand instrument. Another instrument that is typically used to perform scaling or root planing to remove buildup of plaque is an ultrasonic scaler. Typically, dentists inspect the patient's gum and teeth by viewing such areas directly within endoscope. Conventional treatment of such periodontal diseases initially comprises the inspection and identification of specific areas requiring a scaling and/or root planing procedure.

After inspecting and identifying the areas requiring treatment, the dentist removes the endoscope and then inserts the ultrasonic scaler to perform the scaling and/or root planing procedure. After removal of dental plaque via the scaling procedure, the dentist may again reinsert the endoscope after removal of the ultrasonic scaler in order to re-inspect such treated areas of the gum and teeth. This process is repeated until the affected area is treated properly.

In another treatment, the endoscope and the ultrasonic scaler may be simultaneously placed within the patient's mouth during the scaling and/or root planing procedure. In this procedure, a dental assistant may be required to hold and manipulate the endoscope such that the dentist may view a specific area of the gum or teeth to be treated. Unfortunately, as the dentist is performing the procedure, the ultrasonic scaler may block direct viewing of the treated area by the endoscope. When this blockage of the view occurs, the dental assistant must maneuver the endoscope within the patient's mouth such that the dentist may again view the area to be treated.

Accordingly, the dentist must constantly communicate to the dental assistant which view the dentist requires in order to properly perform the scaling and/or root planing procedure. During this communication, the dental assistant may misunderstand the dentist's instructions which may increase the time required to perform the procedure. This increase in treatment time may result in an increase in patient discomfort as the patient must consciously hold their mouth open during the operation. In addition, misunderstandings or miscommunications between the dental assistant and the dentist may lead to frustration of the dentist during the procedure. Even further, the dental assistant may be unable to provide the appropriate view of the area to be treated as desired by the patient due to a lack of maneuverable space for both the dentist's and the dental assistant's hands.

As can be seen, there exists a need in the art for a device that allows a dentist to view a patient's gum and teeth while treating the patient. Furthermore, there exists a need in the art for a device that allows the dentist to view various angles of the patient's gum and teeth while an ultrasonic scaler is inserted into the a patient's mouth for scaling and root planing operations.

### BRIEF SUMMARY OF THE INVENTION

The present invention is specifically adapted to address the above mentioned needs associated with viewing a patient's gums and teeth during certain dental treatments. More specifically, the present invention provides an adapter that integrates an ultrasonic scaler and an endoscope into a single hand tool that may be manipulated by a single hand of the dentist. More particularly, the adapter is specifically configured to allow the tip of the endoscope to be placed adjacent to the tip of the ultrasonic scaler and to be manipulated thereabout without the aid of a dental assistant.

In this manner, as the dentist is treating the patient, the ultrasonic scaler may be moved to various areas of the patient's teeth, gums and mouth. Advantageously, along with each movement of the ultrasonic scaler, the endoscope may be adjusted with respect to its viewing position such that the dentist may directly view the area being treated via the endoscope without blockage by the scaler. In this regard, the endoscope and ultrasonic scaler may be moved relative to one another and be held as a unitary hand instrument.

Furthermore, the adapter is specifically configured to enable the dentist to rotate and/or position the endoscope tip about the ultrasonic scaler tip as needed. For example, as the dentist is treating the patient, the scaler tip may block viewing of an area by the endoscope tip (i.e., via an optical head). The adapter advantageously includes a thumbwheel that the dentist may manipulate in order to rotate the endoscope tip about the scaler tip via: (1) cam action movement between a post of the scaler holder rotating inside an aperture of the tube holder, and, (2) swiveling action of the tube with respect to a pivot aperture of the tube holder. The ability to rotate the endoscope tip about the scaler tip via the two above mentioned movments enables the dentist to obtain an optimal view of the patient's teeth and gums.

The adapter may comprise an endoscope holder and a scaler holder which are removably attached both to one another. The endoscope holder is configured to hold or mount the endoscope via a luer and tube assembly which is attached to the tube holder. The scaler holder is configured to hold the scaler via a scaler aperture, a collet and a lock nut. The aperture and collet may be integrally formed with the scaler holder. The tube of the endoscope holder may be extended through a pivot aperture of the scaler holder and is preferably swivelable therewithin.

The endoscope itself (i.e., fiber optic assembly) may be fed or inserted into the tube of the endoscope holder. The scaler may be secured to the scaler holder and the cam action movement of the post within the endoscope holder aperture allows the endoscope holder to rotate. The pivot aperture is configured to allow for sliding movement of the tube therewithin as the endoscope holder is rotated about a rotational access of the thumbwheel. In this manner, the endoscope tip of the endoscope may be rotated and/or translated about the distal tip of the scaler during treatment procedures.

### BRIEF DESCRIPTION OF THE DRAWINGS

An illustrative and presently preferred embodiment of the invention is shown in the accompanying drawings in which:

FIG. 1 is an exploded elevational view of an adapter of the present invention which is specifically configured as an endoscope holder and an ultrasonic scaler holder;

FIG. 2 is a top view of the endoscope holder and the scaler holder in the assembled state as shown in FIG. 1 and illustrating an endoscope and an ultrasonic scaler being mounted by the endoscope holder and the scaler holder, respectively, and further illustrating rotation of a thumbwheel which results in rotation of an endoscope tip about the distil tip of the scaler;

FIG. 3 is an elevational view of FIG. 2;

FIG. 3A-3A is a cross sectional view of the endoscope tip and distil tip of the scaler of FIG. 2 and illustrating the rotational relationship therebetween as facilitated by rotation of the thumbwheel;

FIG. 4 is an exploded view of the endoscope holder;

FIG. 5 is a top exploded view of a first luer and a second luer of the endoscope holder;

FIG. 6A is a top view of a tube of the endoscope holder;

FIG. 6B is an elevational view of the tube of the endoscope holder;

FIG. 6C is a bottom view of the tube of the endoscope holder;

FIG. 6D is a front view of the tube of the endoscope holder;

FIG. 7 is an elevational view and a bottom view of the endoscope holder in the assembled state;

FIG. 8 is an exploded view of the scaler holder;

FIG. 9 is a top view of the scaler holder of FIG. 8 in the assembled state; and

FIG. 9A-9A is a cross sectional view taken along lines 9A-9A of FIG. 9 illustrating a collet threadably engaged to the scaler holder.

### DETAILED DESCRIPTION OF THE INVENTION

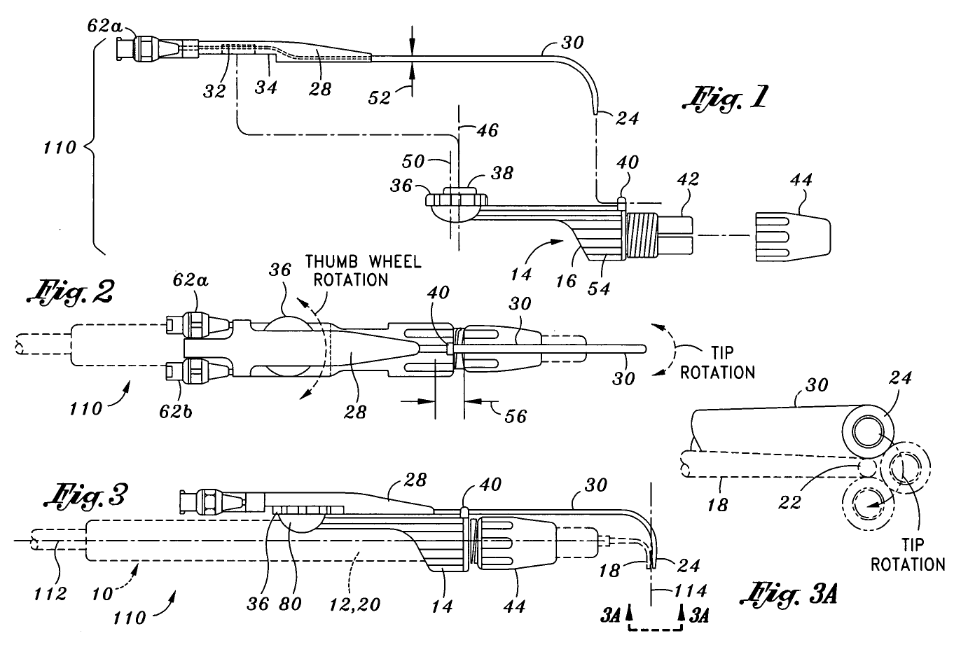

The figures referenced herein are merely for the purposes of illustrating preferred embodiments of the present invention and not for purposes of limiting the same. Shown in FIGS. 1-9A is an adapter 110 which, in its broadest sense, comprises a scaler holder 14 and an endoscope holder 26. The adapter 110 is specifically figured to mount a scaler 10 together with an endoscope 112. More specifically, the adapter 110 is specific configured to mount a distal tip 22 of a scaler 10 in close proximity to an endoscope tip 24 such that the endoscope tip 24 may be selectively moved about the distal tip to facilitate direct viewing of an area that is treated using the scaler 10. The scaler 10 may be an ultrasonic scaler 10 although other types of scalers 10 are contemplated.

The scaler holder 14 is specifically configured to support the scaler 10 and includes a scaler body 12 which may have a cylindrically shaped configuration which also has a cylindrically hollow aperture 16 that is sized and configured to receive the scaler body 12. More specifically, the scaler holder 14 is sized and configured to allow for removable mounting of the scaler body 12. The aperture 16 is preferably sized and configured to receive variously configured or shaped scaler bodies 12 having varying cross sectional shapes such as hexagonal and pentagonal cross section shapes.

As can be seen in FIG. 3, the scaler 10 is illustrated in phantom and may include a working portion 18 and a handle portion 20. The working portion 18 may comprise an elongate member having an L-shaped configuration. As can be seen in FIG. 3A, the working portion 18 may have a circular cross-sectionally shaped distal tip 22. The handle portion 20 or holder body 54 of the scaler 10 may have an elongate cylindrical configuration although other configurations are contemplated. The holder body 54 may define an outside surface which may be smooth and/or textured in order to provide a gripping surface for a dentist who is using the scaler 10. It is contemplated that any type of scaler 10 may be variously employed with the adapter 110 of the present invention.

Also shown in FIG. 1 is the endoscope holder 26 of the adapter 110. The endoscope holder 26 is operatively connected to the scaler holder 14 and is configured to moveably support the endoscope 112. The endoscope 112 may be configured with an elongate body portion configured as a tube 30. It is contemplated that various types of endoscopes may be employed with the adapter 110 of the present invention. The tube 30 of the endoscope 112 terminates at the endoscope tip 24. The endoscope holder 26 may further comprise a tube holder 28 which has the tube 30 fixedly mounted there to in a manner that will be described in greater detail below.

The tube 30 may be configured as a fiberscope tube 30 that is adapted to receive fiber optic elements therewithin. As can be seen in the figures, the tube 30 may have a generally L-shaped configuration adjacent to the endoscope tip 24 and may have an S-shaped configuration at an opposite end thereof.

Importantly, the adapter 110 may further comprise a thumbwheel 36 which eccentrically couples the endoscope holder 26 to the scaler holder 14 in a manner such that rotation of the thumbwheel 36 effectuates rotation of the endoscope tip 24 about the distal tip 22. It should be noted that the term “rotation” as used herein in relation to the thumbwheel 36 and endoscope tip 24 may be more accurately described as a combination of translation of the endoscope tip 24 in a circular motion.

As can be seen in FIG. 3A, rotation of the thumbwheel 36 causes the endoscope tip 24 to move from one side of the distal tip 22 to an opposite side thereof without rotation of the endoscope tip 24 about its own axis. Likewise, rotation of the thumbwheel 36 about its axis 46 effectuates a combination of translation and circular motion of the tube holder 28 about the axis of the thumbwheel 36 46 as will be described in greater detail below. It is contemplated that the thumbwheel 36 is specifically configured such that rotation thereof effectuates at least about 180 degrees of rotation of the endoscope tip 24 about the distal tip 22 of the scaler 10, as can be seen in FIG. 3A.

The scaler holder 14 may fixedly secure the scaler 10 therewithin by means of a collet 42 and a locknut 44. As can be seen in FIGS. 1-3, the collet 42 may have a castellated distal tip 92 having external threads 94 form adjacent thereto. The castellated distal tip 92 may have a conical shape as shown in FIG. 8. The scaler holder 14 may further include the locknut 44 which has internal threads 96 that are sized and configured to engage the collet 42 external threads 94 in a manner to constrict the distal tip 92 for engaging the scaler body 12.

In this manner, the locknut 44 is configured to mate with the collet 42. The collet 42 has a conical inner surface 98 that is preferably sized and configured to engage the distal tip 92 of the collet 42. As the locknut 44 is threaded onto the collet 42 internal threads 96, the conically shaped inner surface 98 of the locknut 44 engages the conically shaped distal tip 92 and causes constriction thereof. In this manner, when the scaler 10 is inserted through aperture 16 (see FIG. 9A-9A), the collet 42 distal tip 92 engages the scaler 10 via tightening of the locknut 44 onto the collet 42.

FIGS. 2 and 3 illustrate top and elevational views of the endoscope holder 26 and the scaler holder 14 in the assembled state. The tube 30 of the endoscope holder 26 may be fed through a pivot aperture 40 formed on the scaler holder 14. The pivot aperture 40 is preferably of a slightly larger diameter than that of the tube 30 in order to allow movement (i.e., swiveling) of the tube 30 within the pivot aperture 40. However, the pivot aperture 40 may have any size to allow the tube 30 to pivot therewithin. Furthermore, the pivot aperture 40 may be rotatably connected to the scaler body 12 of the scaler holder 14. In this regard, the pivot aperture 40 may be attached to the scaler body 12 via a bushing or a bearing (not shown) in order to allow for movement (i.e., swiveling) of the tube 30 relative to the holder body 54 of the scaler holder 14.

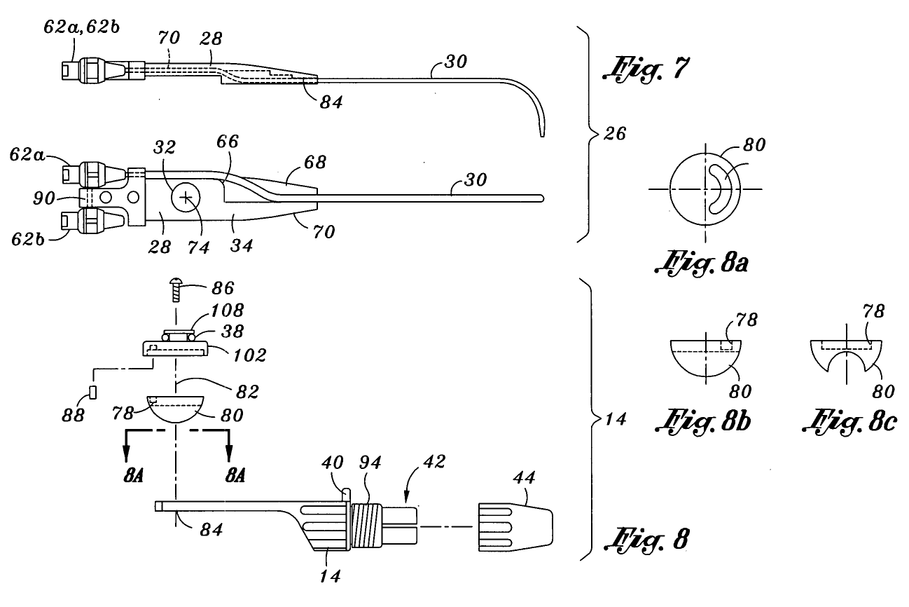

Referring briefly now to FIGS. 6A-6D, shown is the tube 30 in top, elevational, bottom and front views, respectively. As can be seen, the tube 30 may have an S-shaped configuration on one end and an L-shaped configuration on an opposite end. The tube 30 preferably has an outer diameter 52 which is sized and configured to be received by a pivot aperture 40 of the scaler holder 14 and is configured to be swivelable and slightly translatable therewithin in a range defined by middle range 56 as shown in FIG. 2. The tube 30 may also define an inner diameter or thru hole which extends along a length of the tube 30. Preferably, the thru hole is sized and configured to receive the endoscope 112 (i.e., fiber optic elements) therewithin. The endoscope 112 (e.g., fiberscope) may be inserted into the tube 30 and extended along the through hole prior to being fixedly attached to the tube 30.

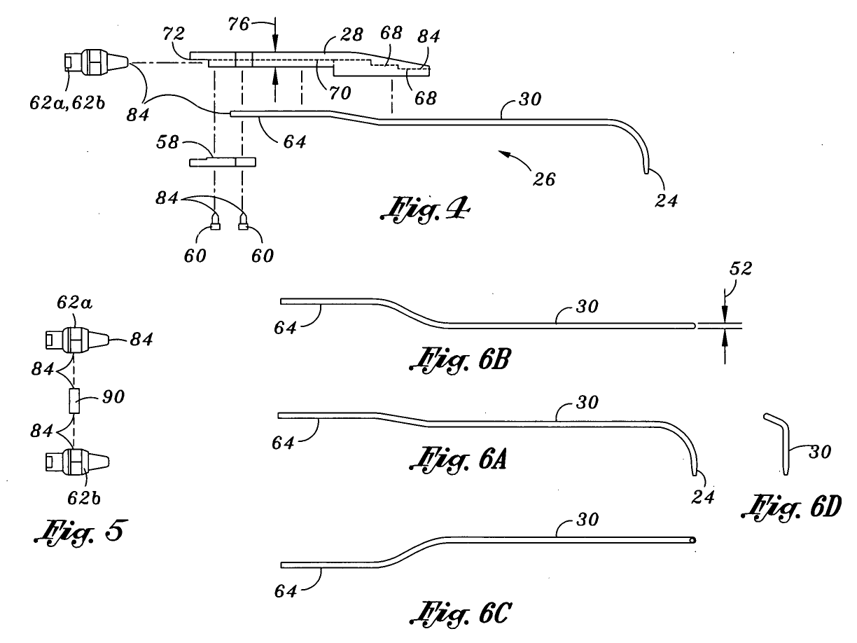

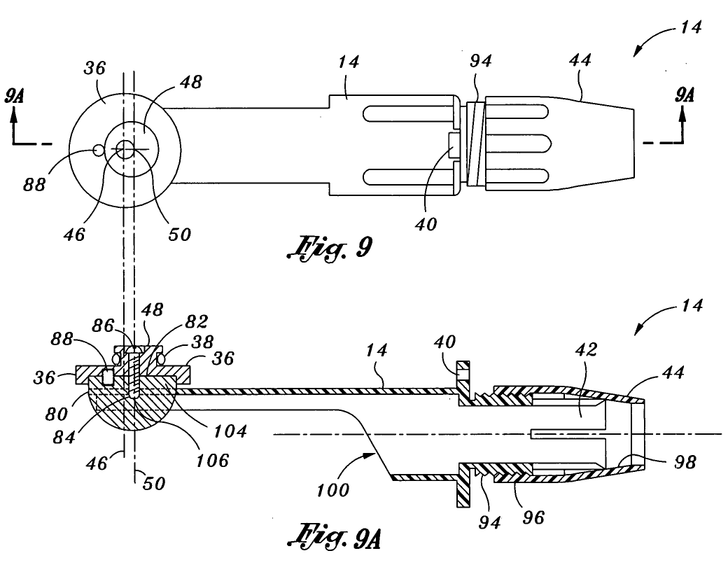

Shown in FIGS. 4 and 7 is the tube holder 28 to which the tube 30 is fixedly secured. The tube holder 28 may include a distal channel 70 which is sized and configured to receive the tube 30. The tube holder 28 may also include a ledge 68 which, as shown in FIGS. 4 and 7, may be comprised of a series of steps formed in the tube holder 28. The tube 30 may be attached to a lower portion of the ledge 68 via adhesive 84 as shown in FIG. 7. As shown in FIGS. 6A-6C, the tube 30 is sized and configured to conform to the distal channel 70 and ledge 68 of the tube holder 28.

As can be seen in FIG. 7, the tube holder 28 includes a central portion 66 about which the tube 30 bends while extending aftwardly to the free end of the tube holder 28. At a proximal end 64 of the tube 30, a pair of luers 62a, 62b may be provided. One of the luers 62 may be configured in the shape of a tube luer 62a while the other one of the luers 62 may be configured as an irrigation luer 62b. The tube 30 is preferably connected to the tube luer 62a as shown in FIG. 2. The irrigation luer 62b is preferably mounted adjacent to the tube luer 62a and is configured to provide fluids to an area adjacent to the distal tip 22 of the scaler 10. For such a configuration, it is contemplated that an additional tubing element may be provided with the tube holder 28 in order to direct fluid from the irrigation luer 62b to the area adjacent to the distal tip 22 of the scaler 10.

The tube luer 62a is preferably sized and configured to receive the proximal end 64 of the tube 30 and, in this regard, is preferably of a compatible diameter. The tube luer 62a may be additionally be configured to enabling securing of the tube 30 at a proximal end 72 of the tube holder 28. As shown in the figures, the tube 30 may be affixed to the tube holder 28 via adhesive 84 at least one area of the ledge 68, and also via connection to the tube luer 62a disposed on an opposite end of the tube holder 28. However, it is contemplated that other mechanical devices or features may be provided with the tube holder 28 to mount the tube 30 there to.

As shown in FIG. 4, the endoscope holder 26 may further comprise a backplate 58 having a generally T-shaped configuration which is configured to clamp the tube proximal end 64 to the tube holder 28 via a pair of screws 60. The backplate 58 may provide additional holding force to fixate and mount the tube 30 to the tube holder 28. However, the tube 30 may be mounted to the tube holder 28 or snapped onto the tube holder 28 via clips (not shown) that may be formed along the tube holder 28. Optionally, adhesive 84 may be additionally used along the tube holder 28 to fix the tube 30 thereto.

The backplate 58 may have the T-shaped configuration wherein outwardly extending elements protrude therefrom. Likewise, the tube holder 28 may have a complimentary set of laterally outwardly extending elements. Such laterally outwardly extending elements are of a sufficient width to clamp the tube 30 between the tube holder 28 and the backplate 58. As can be seen in FIG. 5, the tube luer 62a and irrigation luer 62b may be interconnected to one another by means of a tubing segment 90 which connects the tube luer 62a to the irrigation luer 62b such as using adhesive 84.

Each one of the luers 62 may include an aperture sized and configured to receive the tubing segment 90 therewithin. As can be seen in FIG. 2 and FIG. 4, the combination of the tube luer 62a, irrigation luer 62b and tubing segment 90 may be mounted between the backplate 58 and the tube holder 28 by means of complimentary notches formed in the tube holder 28 and the backplate 58.

In the assembled state, the endoscope holder 26 may comprise the tube 30, the tube holder 28, the backplate 58, and the tube luer 62a and irrigation luer 62b interconnected by the tubing segment 90. The tube 30 may be connected to the tube holder 28 via adhesive 84 applied at the ledge 68 as well as the connection of the tube proximal end 64 to the tube luer 62a. Furthermore, the backplate 58 may serve to clamp the tube 30 to the tube holder 28. Although the tube holder 28 is shown with the specific configuration as illustrated in FIG. 4, it is contemplated that the tube holder 28 may be provided in a variety of alternative shapes and sizes.

The tube holder 28 is preferably suitable to mount the tube 30 thereto such that rotation of the thumbwheel 36 effectuates pivoting action at the pivot aperture 40 and ultimately, rotation of the endoscope tip 24 about the distal tip 22 of the scaler 10. For example, although the distal channel 70 was mentioned as being disposed adjacent the tube luer 62a and irrigation luers 62b, the distal channel 70 may optionally be formed along any portion of the tube holder 28 and is preferably configured to allow the tube 30 to be retained to the tube holder 28.

Referring now to FIG. 7, shown is the tube holder 28 having a bottom surface 34 with an aperture 32 formed therewithin. The aperture 32 may be generally defined as a cylindrical bore extending at least partially within the tube holder 28 and, optionally, extending across an entire thickness 76 of the tube holder 28. The aperture 32 defines a central axis 74 thereof. As can be seen in FIG. 9A, the scaler holder 14 has the thumbwheel 36 mounted thereon. More specifically, a boss 80 may be provided to interface between the scaler body 12 and the thumbwheel 36.

Mounted atop the boss 80 may be the thumbwheel 36 itself with a washer 82 being interposed between the thumbwheel 36 and the boss 80. Extending upwardly from the thumbwheel 36 may be a post 48 having a circumferential lip 108 and a circumferential groove 78 formed therearound for receiving an O-ring 38. Preferably, the post 48 and the O-ring 38 have outer diameters that are sized to be received within the aperture 32 of the tube holder 28 bottom surface with a sliding fit therebetween. In this manner, rotation of the thumbwheel 36 may effectuate pivoting translation of the tube 30 relative to the pivot aperture 40 which, in turn, effectuates arcuate translating motion of the endoscope 112 about the distal tip 22.

As can be seen in FIGS. 8 to 9A, the post 48 of the thumbwheel 36 is eccentrically mounted on the thumbwheel 36 and extends upwardly therefrom. In this manner, the thumbwheel 36 and, hence, the post 48, eccentrically couple the endoscope holder 26 to the scaler holder 14 such that rotation of the thumbwheel 36 causes movement of the tube holder 28. Mounting of the thumbwheel 36 on the scaler holder 14 is facilitated through the use of the boss 80 which has an arcuate bottom surface that is shaped and sized complimentary to the cylindrical outer surface of the scaler body 12.

As can be seen in FIG. 8A, the boss 80 has a generally plainer upper surface that is configured to interface with a depression 104 formed on the underside 102 of the thumbwheel. The washer 82 disposed between the thumbwheel 36 and the boss 80 allows for minimal frictional resistance therebetween during rotation of the thumbwheel 36. A screw 86 may be extended through the post 48 and thumbwheel 36 and washer 82 and into the boss 80 before engaging a threaded hole 106 of the scaler body 12. Adhesive 84 may be applied on an end of the screw 86 in order fix the screw 86 against rotation thereof. Preferably, the screw 86 is tightened such that the thumbwheel 36 may rotate freely without wobbling.

Referring still to FIG. 8A, the boss 80 may include an arcuately shaped groove 78 formed in the upper plain surface. A pin 88 may be fixedly secured to the thumbwheel 36 and extends downwardly to engage the groove 78 formed in the boss 80. Such groove 78 may serve to limit rotational motion of the thumbwheel 36. Although the boss 80 is shown as a separate component distinct from the scaler body 12, it is contemplated that the boss 80 may be intricately formed with scaler body 12 in order to provide a planar mounting surface for the thumbwheel 36 depression 104.

By configuring the thumbwheel 36 such that the O-ring 38 fits within the adapter 110, the endoscope holder 26 may be easily removed from the tube holder 28 by merely pulling the tube holder 28 off of the post 48 and sliding the tube 30 out of the pivot aperture 40 disposed on the scaler body 12. The thumbwheel 36 is preferably ergonomically shaped to allow for secure grasping and rotation thereof.

In this regard, the thumbwheel 36 may include a ribbed outer perimeter and may be generally circularly shaped. The O-ring 38 is preferably fabricated of elastomeric material such as rubber in order to facilitate a sliding fit with the aperture formed in the tube holder 28 bottom surface. In this regard, the thumbwheel 36 may have a predetermined amount of frictional force which prevents unintentional rotation of the thumbwheel 36 and, hands, movement of the endoscope tip 24, after adjustment of the thumbwheel 36 by the dentist.

As can be seen in FIGS. 9 and 9A, the thumbwheel 36 defines a rotational axis 46 and the post 48 defines a central axis 50. The rotational axis 46 and the central axis 50 are preferably offset from one another such that rotation of the thumbwheel 36 causes eccentric rotation of the post 48 about the rotational axis 46. In this regard, rotational movement of the thumbwheel 36 is operative to effectually rotation of the endoscope tip 24 about the distal tip 22 of the scaler 10. Because the post 48 is seated within the pivot aperture 40 of the tube holder 28 and because the tube 30 is fixedly swivelable within the pivot aperture 40, the endoscope tip 24 may be arcuately translated about the distal tip 22 of the scaler 10 in a corresponding manner.

As such, a dentist may selectively position the endoscope tip 24 about the scaler 10 tip in order to obtain an optimal view of a patient's teeth while treating the patient. If the irrigation luer 62b is utilized, irrigation fluid such as water may be provided to the treatment area adjacent the tooth surface during scaling operations. It is contemplated that the adapter 110 is configured to incorporate handling requirements for such irrigation provisions.

The adapter 110 may be fabricated of various materials. For example, it is contemplated that the endoscope holder 26 and the scaler holder 14 as well as the thumbwheel 36 components may be fabricated from suitable materials including, but not limited to, plastic, metal, and other suitable materials and/or combinations thereof.

The description of the various embodiments of the present invention is presented to illustrate preferred embodiments thereof and other inventive concepts may be otherwise variously embodied and employed. The appended claims are intended to be construed to include such variations except insofar as limited by the prior art.

What is claimed is:

1. An adapter for movably mounting a distal tip of a scaler in close proximity to an endoscope tip of an endoscope, the adapter comprising:
a scaler holder configured to support the scaler;
an endoscope holder connected to the scaler holder and being configured to movably support the endoscope;
a thumbwheel eccentrically coupling the endoscope holder to the scaler holder and being configured such that rotation of the thumbwheel effectuates rotation of the endoscope tip about the distal tip.

2. The adapter of claim 1 wherein the thumbwheel is mounted on the scaler holder.

3. The adapter of claim 1 wherein the thumbwheel is configured such that rotation thereof effectuates at least about one-hundred-eighty degrees of rotation of the endoscope tip about the distal tip.

4. The adapter of claim 1 wherein:
the scaler includes an elongate cylindrical scaler body having an elongate working portion extending axially outwardly therefrom and terminating in the distal tip;
the scaler holder including a holder body sized and configured to mount the scaler body thereto.

5. The adapter of claim 1 wherein the scaler holder is configured to removably mount the scaler body thereto.

6. The adapter of claim 5 wherein the scaler holder includes:
a collet having a castellated distal tip with external threads formed adjacent thereto;
a locknut having internal threads and being sized and configured to engage the collet threads in a manner to constrict the distal tip for engaging the scaler body.

7. The adapter of claim 1 wherein:
the endoscope includes a tube terminating at the endoscope tip;
the endoscope holder comprises a tube holder having the tube fixedly mounted thereto.

8. The adapter of claim 7 wherein:
the scaler body includes a pivot aperture sized and configured to receive the tube therethrough;
the tube holder being configured such that rotation of the thumbwheel effectuates pivoting movement of the tube relative to the pivot aperture effectuating rotation of the endoscope tip about the distal tip.

9. The adapter of claim 8 wherein the pivot aperture is disposed in spaced relation to the thumbwheel.

10. The adapter of claim 1 wherein:
the scaler holder defines an adapter axis extending axially therealong;
the distal tip defining a tip axis oriented perpendicular to the adapter axis;
the endoscope tip being aligned with the tip axis.

11. The adapter of claim 1 wherein:
the tube holder including an aperture formed on a bottom surface thereof;
the thumbwheel including a post eccentrically mounted thereon and extending upwardly therefrom, the post being sized and configured to rotate inside of the tube holder aperture to effectuate rotation of the endoscope tip about the distal tip.

12. The adapter of claim 1 wherein:
the endoscope includes a tube terminating at the endoscope tip;
the endoscope holder includes a tube luer mounted on a proximal end thereof and being connectable to the tube;
the endoscope holder further including an irrigation luer mounted thereon adjacent to the tube luer and being configured to provide fluids to an area adjacent to the distal tip of the scaler.

13. The adapter of claim 1 wherein the scaler is configured as an ultrasonic scaler.

14. The adapter of claim 1 wherein:
the thumbwheel includes an eccentrically mounted post extending upwardly therefrom;
the tube holder having an aperture sized and configured to receive the post for rotation of the tube holder relative to the thumbwheel.

15. The adapter of claim 14 wherein:
the post has an o-ring extending therearound;
the aperture sized being sized and configured to receive the o-ring therein.

16. The adapter of claim 14 wherein the aperture and the o-ring are sized and configured to provide a predetermined amount of frictional sliding force therebetween to resist thumbwheel rotation after selective manual positioning thereof.

17. The adapter of claim 1 wherein the thumbwheel is configured to limit rotational motion of the endoscope holder relative to the scaler holder.

18. The adapter of claim 17 wherein:
the scaler holder includes a boss mounted thereon and being configured to rotatably mount the thumbwheel thereon, the boss having an arcuate groove formed therein;
the thumbwheel including a pin fixedly engaged thereto, the pin being slidably engagable to the groove;
the groove having an arc length sized and configured to limit movement of the pin therewithin for limiting angular rotation of the thumbwheel.

19. The adapter of claim 7 wherein the endoscope holder includes a backplate mounted thereto and being configured to capture the tube between the tube holder and the backplate.

20. The adapter of claim 7 wherein the tube is fabricated of polymeric material.
